(19) United States
(12) Patent Application Publication
(10) Pub. No.: US 2016/0009532 A1
(43) Pub. Date: Jan. 14, 2016

(54) Log lift and pulling apparatus for cooperation with log splitter

(71) Applicant: John Bennette, Point Pleasant, NJ (US)

(72) Inventor: John Bennette, Point Pleasant, NJ (US)

(21) Appl. No.: 14/120,941

(22) Filed: Jul. 14, 2014

(51) Int. Cl. B66C 23/18; B66C 23/62; B27L 7/00

(52) U.S. Cl. CPC B66C 23/18; B27L 7/00; B66C 23/62

(57) ABSTRACT

A lift apparatus cooperable with a log splitter for lifting log sections onto and positioning the log sections on the log splitter for splitting, the lifting apparatus having a frame member removably secured to the frame of the log splitter and supported by the underlying substrate, the frame defining an upwardly extending pedestal having a vertical post member secured thereto having a transverse lifting boom secured to the upper end of the vertical member, the lifting boom supporting a cable spool and electric motor, the lifting boom articulating in the vertical frame in response to a hydraulic control, the lifting boom rotatable about said support post, the cable having a lifting tong secured to its end for engaging log sections and lifting onto said log splitter, or for engaging log sections a distance from the log splitter and dragging them to the log splitter for lifting.

### BACKGROUND OF THE INVENTION

1. Field of the Invention

The present invention relates to a lift apparatus, and in particular, a lift apparatus cooperative with a log splitter which allows for the lifting of large sections of logs or rounds and positioning them on the splitter for splitting them into smaller more easily handled pieces, and also for the gathering of log sections and pulling them into proximity of the splitter for lifting and splitting.

2. Description of the Prior Art

Built-in fire places and wood stoves are popular additions to dwellings and residences, not only for aesthetics, but also for practical use in that they can lower the energy bills for the dwelling or residence. Wood stoves are extremely popular in certain rural areas where the choice of energy may be limited to either electric, gas or fuel oil. The wood stove provides an alternative source for reducing energy bills and maintaining a comfortable temperature within the dwelling or residence.

Logs can typically be split by hand if the log is of such dimensions and such weight such that it allows the individual to position the log in the correct position for addressing the log with either an ax or a sledge and wedge in order to split the log into smaller more easily handled pieces for transport and use, particularly of a correct size for positioning in a wood stove or a fireplace. Larger log sections which are referred to in the trade as “rounds” come from the trunk of the tree.

The splitting of the logs has become easier with the development of automated mechanical devices which split the logs or rounds. These devices make use of an anvil/stop end and a wedge end, the wedge end driven by hydraulic pressure which can split the log which is cylindrical in shape from a tree trunk into halves, quarters and eighths. Depending upon the location, the availability of timber, and the desire for energy consumption, log splitters of this type are not only utilized by professional log splitters who supply split logs to end users for a living, but the log splitters have become economical in that individuals can afford to own a log splitter and use it for his own single dwelling or residence.

The only draw back that the individual has in operating his own log splitter, is the fact that he alone is positioning the log on the log splitter. Oftentimes the section of log supplied from a fresh cut tree trunk or the like is of such a diameter and weight that an individual cannot easily lift it and position it on the splitter. Sometimes these log sections can weigh as much as 300 pounds or more. These sections or “rounds” as known in the trade typically come from the trunk of the tree and are cut to approximately 18-24 inch lengths, that being the typical length acceptable to fire places and wood stoves. The diameter of these rounds vary depending on the size of the tree and hence the variation in weight.

There therefore has been a need for a apparatus which would more easily allow an individual to lift and position a section of log on a splitter machine so that the log could be split into the appropriate sizes for easier transportation and use in a fireplace or wood stove. Many attempts have been made to solve this problem. These attempts including inclined ramps to roll the log, or a completely separate mobile machine having a claw which would lift the log into position and alignment with the splitter.

Applicant's apparatus is a lifting apparatus mounted on a frame, the frame cooperative with the frame of the splitter to position the lifting apparatus at a proper location and height and to stabilize the lifting apparatus so that the lifting apparatus can be manipulated by a single individual through a series of controls capable of lifting a 300 pound or more log section or round into the air and positioning them on the splitter. The lifting apparatus can also be used to attach a log section or round which is some distance away from the splitter and drag the log section or round into proximity of the lifting device for vertical lifting and positioning on the splitter.

### OBJECTS OF THE INVENTION

An object of the present invention to provide for a novel lifting apparatus for lifting log sections onto a log splitter.

A still further object of the present invention to provide for a novel lifting apparatus which is mounted on a frame, the frame being cooperable with and secured with the frame of the splitter to provide stability to the frame and the lift apparatus, as well as the splitter while manipulating a log into position on the splitter.

A further object of the present invention is to provide for a novel lifting apparatus which can be easily manipulated and positioned by a single individual.

A further object of the present invention to provide for a novel lifting apparatus for use in cooperation with a log splitter which allows for the facile lifting of heavy log sections.

A still further object of the present invention is to provide for a novel lifting apparatus for use in cooperation with a log splitter wherein the lifting apparatus can also be utilized to attach to a log section or round positioned some distance from the lifting apparatus and to pull that log section or round into proximity of the lifting apparatus and the splitter for lifting and positioning.

### SUMMARY OF THE INVENTION

A lift apparatus cooperable with a log splitter for lifting log sections onto and positioning the log sections on the splitter for splitting of the logs, the lifting apparatus having a frame member which is removably secured to the frame of the log splitter, the frame apparatus further having support on the underlying substrate, the frame apparatus defining an upwardly extending pedestal having mounted thereon a vertical member having a lifting boom angularly secured thereto, the lifting boom having a depending cable with tong member secured thereto, the boom member and a portion of the vertical member rotatable, the boom member and cable responsive to hydraulic control for movement of the boom up and down and an electric motor for the retraction and release of the cable member, the lifting apparatus also able to engage a log section or round at some distance from the lifting apparatus and splitter, and to drag or pull that log section or round into proximity of the lifting device for vertical lifting and positioning on the log splitter.

### BRIEF DESCRIPTION OF THE DRAWINGS

These and other objects of the present invention will become apparent, particularly when taken in light of the following illustrations wherein:

FIG. 1 is a side view of a typical log splitter and the lifting apparatus of the present invention;

FIG. 2 is an end view of the lifting apparatus in cooperation with a splitter of the present invention;

FIG. 3 is a close up side view of the support frame of the lifting apparatus of the present invention removably secured to a log splitter; and

FIG. 4 is a side view of the lifting apparatus secured to the support frame which is removably secured to the log splitter illustrating the manner in which the lift apparatus can pull or gather log sections or rounds from a distance proximately to the splitter for lifting.

### DETAILED DESCRIPTION OF THE INVENTION

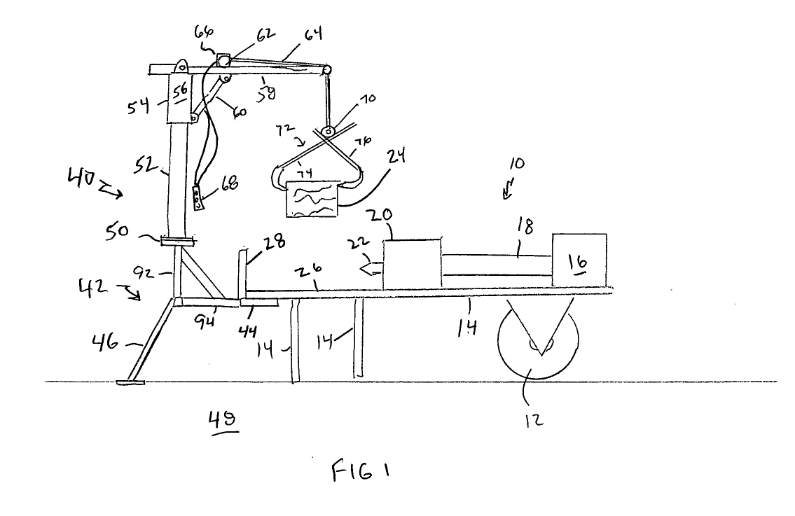

FIG. 1 is a side view illustrating a log splitter and the lifting apparatus of the present invention. The log splitter 10 is mounted on a pair of wheels 12, and contains a frame and legs 14 which supports a motor 16 and a hydraulic piston 18. The hydraulic piston 18 has at its operational end 20 a wedge 22 for splitting log sections or rounds 24. The wedge moves on a platform 26 from its retracted position towards an anvil/stop 28. The anvil/stop 28 is firmly secured to the frame 14 of log splitter 10. It can be seen in FIG. 1 that a round 24 is placed on platform 26 of log splitter 10 in alignment between the retracted wedge 22 and the anvil/stop 28. The hydraulic pressure of the log splitter, which in some models equals 38,000 pounds, sends the piston 18 and wedge 22 forward with such force that it splits the round at least in half.

The rounds are typically generated from the trunk of a tree which may have fallen naturally, or intentionally felled by a saw. They can vary in length and diameter depending upon the size of the tree, but for ease of splitting, they are typically reduced to an 18 to 24 inch length prior to being introduced onto log splitter 10.

Applicant's lift device 40 is removably secured to log splitter 10 underneath the anvil/stop 28. The frame 42 for the lifting device is slidably receivable within a receptacle 44 on the underside of the anvil/stop, much like a car or truck hitch. The frame 42 is further formed to provide further reinforcement through adjustable legs 46 which contact the substrate 48, either the ground, or a concrete pad. The frame 42 supports a platform 50 on which the actual lifting device 40 is secured. The lifting device 40 comprises an upward standing post or stanchion 52 rigidly secured to platform 50, the upper portion of the post or stanchion 52 supports a rotatable sleeve 56 onto which is secured a boom member 58 which extends outwardly and which is simultaneously rotatable with sleeve 56. Between the boom member 58 and the rotatable sleeve 56, there is secured a hydraulic piston member 60 for raising and lowering the angle of the boom member 58 in relationship to the rotatable sleeve 56.

Mounted on the boom member 58 is a winch sprocket 62 having wrapped and secured thereto, a cable 64, the winch sprocket having an electric motor 66 attached thereto. The electric motor 66 and winch member 62, together with the hydraulic piston operating the angular orientation of boom member 58 are attached and operated by a hand held control apparatus 68.

The cable 64 is secured to an O-ring 70, to which is attached an articulating tong member 72 having two articulating arms 74 and 76 terminating with inwardly depending pointed fingers designed to engage and penetrate the ends of a round 24 for lifting.

Typically, the cable 64 is extended so that the operator can spread the tongs 72 and then close the tongs 72 upon the ends of a round 24 to be lifted. If necessary, the ends of the tong arms can be hammered into the ends of the rounds to secure the grip. The cable would then be retracted in order to lift the round to the desired height. The rotatable sleeve 56 and boom member 58 would then be rotated to position the round 24 on platform 26 between the wedge 22 and the anvil/stop 28 of the log splitter. The hydraulic mechanism of the log splitter would then be activated driving the wedge into and through the round.

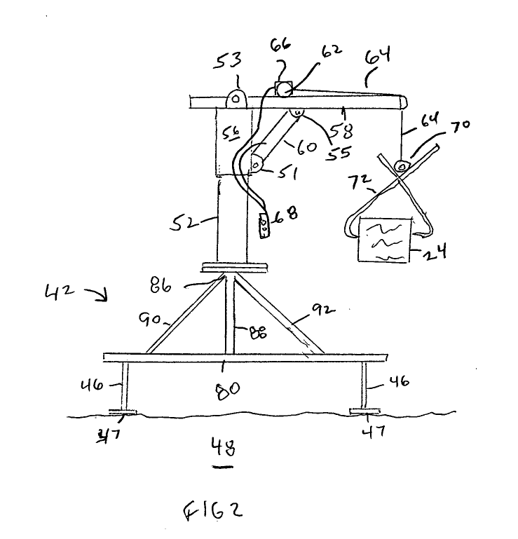

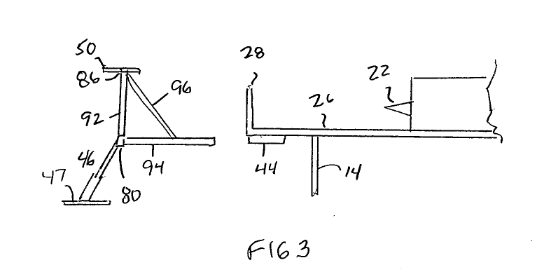

FIG. 2 is a front view of the frame and lift support apparatus and FIG. 3 is a side close up view of the frame apparatus and the elements thereof. The frame 42 comprises a first horizontal member 80 oriented perpendicular to the path of the wedge 22 in relationship to the anvil/stop 28. The first horizontal member 80 is preferably fabricated out of a tubular seal having a square cross section, and its length is sufficient to span the width of the log splitter 10. First horizontal member 80 has adjustable legs 46 proximate each of its terminal ends, the adjustable legs 46 designed to engage the substrate 48, be it the earth or a concrete pad. Preferably, the first horizontal member 80 is oriented such that the depending leg members 46 are not vertical to the substrate, but rather at an angle, angled away from the anvil/stop so that the frame 42 remains stable with respect to the substrate 48 during lifting and pulling or gathering of the rounds as more fully described hereafter.

Secured to first horizontal member are a plurality of upwardly extending frame members, which terminate at an apex 86. An upwardly extending vertical member 88 centrally oriented on the first horizontal member 80 is joined at apex 86 by angular frame member 90 and 92 extending upwardly from first horizontal member 80. Extending horizontally from the lower portion of the vertical horizontal member 88 is a second horizontal member 94 fabricated from tubular steel having dimension a which is slidably receivable in a hitch receptacle 44 which is secured to the underside of the log splitter 10 below the anvil/stop 28, similar to a receptacle found on vehicles for towing trailers. This horizontal frame member 94 removably secured within the hitch receptacle 44 also has secured thereto an upwardly extending angled support arm 96 which terminates in conjunction with the other upwardly extending arms at apex 86. The upwardly extending arms form or may support upwardly extending gussets, which in turn support rigid horizontal platform plate 50. It is on platform plate 50 that the actual lift device 40 is secured.

The lift device comprises a horizontal support plate securable to the support plate of the frame member. Rigidly secured to the lift apparatus support plate is an upwardly extending post or stanchion 52. Upwardly extending post 52 terminates with an upper portion comprised of a rotatable sleeve 56 which is rotatable in a 360 degree arc. Rotatable sleeve has a lower support bracket 51 and an upper support bracket 53. The upper support bracket supports a horizontal boom member 58 rotatable in a vertical plane. The lower bracket 51 forms the anchor base for a hydraulic member 60 which is further secured to the boom member by a support bracket 55. The hydraulic member 60 controls the upward and downward articulating movement of the boom member 58. Secured to the boom member is a winch sprocket 62 and cable 64 powered by an electric motor 66. The electric motor and the hydraulic member are controlled by a hand held control member 68 in communication with both the electric motor and the hydraulic member to control the articulating movement of boom member 58 and the release and retraction of cable 64 from spool/winch 62.

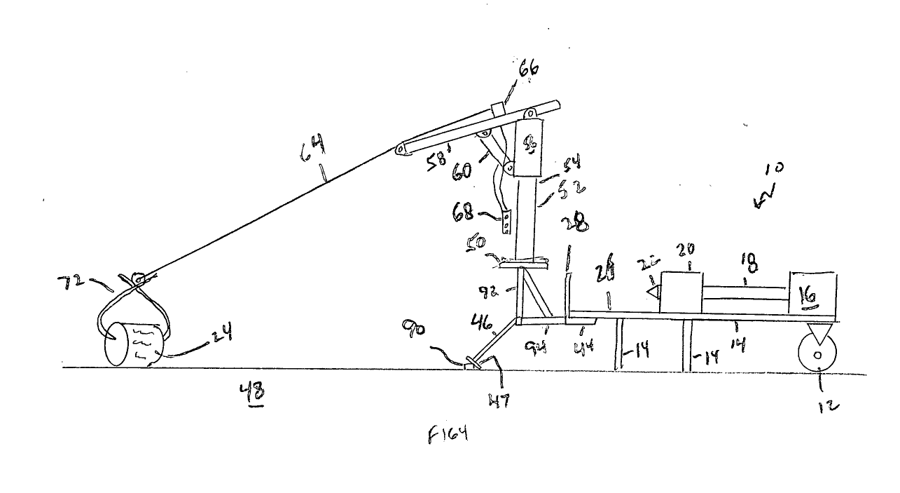

FIG. 4 is a side view of the lifting apparatus secured to support frame which is removably secured to the log splitter as illustrated in FIG. 1. In FIG. 4, the lifting apparatus is illustrated with respect to its ability to play out cable 64 and attach to a log section or round 24 and to drag or pull that log section or round 24 into proximity of the lifting device 10 so that it can be vertically lifted and positioned on the log splitter 10. The reference numerals in FIG. 4 refer to the same structural elements as set forth in FIGS. 1, 2, and 3.

FIG. 4 further illustrates the rotatability of sleeve 56 and boom 58 and also the articulating ability of boom 58 responsive to hydraulic piston 60 in response to control unit 68. One added feature illustrated in FIG. 4 is a horizontal reinforcing support 90 in contact with substrate 48 and secured to the lower ends of legs 46. Reinforcing support 90 provide additional lateral and torsion support when lifting apparatus 40 is used in the manner illustrated in FIG. 4, when a log section or round 24 is drawn or pulled from a distance. Legs 46 in FIG. 4 also illustrate optional foot or anti-skid pads 47 on the lower end of legs 46.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A lift apparatus for use in cooperation with a log splitter for lifting and positioning log segments on the platform of the splitter for splitting the log, the log splitter having a support, a frame, a platform supported by said frame, said platform having secured to one longitudinal end thereof, a stationary anvil/stop, and at an opposing end of said platform a hydraulically operated wedge and hydraulic piston and impulse means for projecting said wedge toward said anvil/stop, the log segment to be split being positioned there between, the lift apparatus comprising:
a frame positioned rearwardly from said anvil/stop, said frame having a first horizontal member oriented perpendicular to the direction of said wedge, said first horizontal member having a plurality of adjustable legs depending from proximate the terminal ends thereof, a second horizontal member in the same plane as said first horizontal member and perpendicular thereto at a proximate midpoint, said second horizontal member slidably receivable within a hitch secured to the underside of said platform of said log splitter;
a vertical support member extending vertically from said first horizontal frame member and position proximate to the midpoint thereof;
a first and second upwardly angled member on either side of said vertical member, said angled members secured to said first horizontal member and terminating proximate the upper end of said vertically oriented member and a third upwardly angled member secured to said second horizontal member and terminating proximate an upper point of said vertical member;
a platform member secured at a juncture of said vertical member and said upwardly angled members, said platform member in a horizontal orientation having an upwardly extending vertical support post member extending there from and fixed to said platform member;
a rotatable sleeve member rotatably secured to an upper end of said post member, said sleeve member for 360 degree rotation about said post member, said sleeve member having a first bracket member secured to a lower end, and a second bracket member secured to an upper end;
an articulating boom member secured to said upper bracket of said sleeve member, said boom member extending outwardly from said sleeve member, said boom member having a bracket formed on its underside, there being secured between said underside bracket of said boom member and said lower bracket of said sleeve member a hydraulic piston member for controlling the articulating upward/downward movement of said boom member;
a spool winch member and motor secured to said boom member, said spool winch member having a cable secured thereto extending to an outward end of said boom member, said cable member having secured to its end an articulating tong member having a plurality of arms having inwardly opposing gripping points for engagement with a log section;
a control member associated with said lift apparatus, said control member and controls in communication with said motor of said spool winch and said hydraulic piston member to control the play out/retraction of said cable and said articulation of said boom member.

2. The lift apparatus in cooperation with a log splitter in accordance with claim 1 wherein said downwardly depending legs are adjustable in height to compensate for an uneven substrate.

3. The lift apparatus in cooperation with a log splitter in accordance with claim 1 wherein said downwardly depending legs are formed with skid plates to improve the grip of the support legs with the substrate.

4. The lift apparatus in cooperation with a log splitter in accordance with claim 1 wherein said tongs of said lift apparatus may engage a log segment at the ends of said log segment or the circumference of said log segment and positioning said log segment on said platform of said log splitter intermediate the said wedge and said anvil/stop.

5. The lift apparatus in cooperation with a log splitter in accordance with claim 1 wherein said cable and said tongs may be fed out to engage a distant log section and said spool, winch, and motor engaged to drag said log section proximate said lift apparatus for lifting to said platform of said log splitter.

6. The lift apparatus in cooperation with a log splitter in accordance with claim 5 wherein said downwardly depending legs contact a third horizontal cross member in contact with the substrate to provide further resistance to lateral forces generated by said lift apparatus when dragging said log section from a distance.

7. A lift apparatus for use in cooperation with a log splitter for lifting and positioning log segments on the platform of the splitter for splitting the log, the lift apparatus comprising:
a frame positioned rearwardly from an anvil/stop, said frame having a first horizontal member oriented perpendicular to the direction of log splitter, said first horizontal member having a plurality of adjustable legs depending from proximate the terminal ends thereof, a second horizontal member in the same plane as said first horizontal member and perpendicular thereto at a proximate midpoint, said second horizontal member slidably receivable within a hitch secured to the underside of said log splitter;
a vertical support member extending vertically from said first horizontal frame member and position proximate to the midpoint thereof;
a first and second upwardly angled member on either side of said vertical member, said angled members secured to said first horizontal member and terminating proximate the upper end of said vertically oriented member and a third upwardly angled member secured to said second horizontal member and terminating proximate an upper point of said vertical member;
a platform member secured at a juncture of said vertical member and said upwardly angled members, said platform member in a horizontal orientation having an upwardly extending vertical support post member extending there from and fixed to said platform member;
a rotatable sleeve member rotatably secured to an upper end of said post member, said sleeve member for 360 degree rotation about said post member, said sleeve member having a first bracket member secured to a lower end, and a second bracket member secured to an upper end;
an articulating boom member secured to said upper bracket of said sleeve member, said boom member extending outwardly from said sleeve member, said boom member having a bracket formed on its underside, there being secured between said underside bracket of said boom member and said lower bracket of said sleeve member a hydraulic piston member for controlling the articulating upward/downward movement of said boom member;
a spool winch member and motor secured to said boom member, said spool winch member having a cable secured thereto extending to an outward end of said boom member, said cable member having secured to its end an articulating tong member having a plurality of arms having inwardly opposing gripping points for engagement with a log section;
a control member associated with said lift apparatus, said control member and controls in communication with said motor of said spool winch and said hydraulic piston member to control the play out/retraction of said cable and said articulation of said boom member.

8. The lift apparatus in cooperation with a log splitter in accordance with claim 7 wherein said downwardly depending legs are adjustable in height to compensate for an uneven substrate.

9. The lift apparatus in cooperation with a log splitter in accordance with claim 7 wherein said downwardly depending legs are formed with skid plates to improve the grip of the support legs with the substrate.

10. The lift apparatus in cooperation with a log splitter in accordance with claim 7 wherein said cable and said tongs may be fed out to engage a distant log section and said spool, winch, and motor engaged to drag said log section proximate said lift apparatus for lifting to said platform of said log splitter.

11. The lift apparatus in cooperation with a log splitter in accordance with claim 7 wherein said downwardly depending legs contact a third horizontal cross member in contact with the substrate to provide further resistance to lateral forces generated by said lift apparatus when dragging said log section from a distance.

12. The lift apparatus in cooperation with a log splitter in accordance with claim 11 wherein said tongs of said lift apparatus may engage a log segment at the ends of said log segment or the circumference of said log segment and positioning said log segment on said platform of said log splitter intermediate the said wedge and said anvil/stop.
